(19) United States
(12) Patent Application Publication
(10) Pub. No.: US 2009/0253420 A1
(43) Pub. Date: Oct. 8, 2009

(54) METHODS AND SYSTEMS FOR PROVIDING ENHANCED GLOBAL LOCAL CALLING

(76) Inventors: Robert J. Stewart, Soquel, CA (US); Richard Anthony Mizer, San Francisco, CA (US); David A. Shier, Solvang, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/418,096

(22) Filed: Apr. 3, 2009

Related U.S. Application Data
(63) Continuation-in-part of application No. PCT/US07/80352, filed on Oct. 3, 2007.
(60) Provisional application No. 60/848,905, filed on Oct. 3, 2006.
(60) Provisional application No. 60/855,845, filed on Nov. 2, 2006.
(60) Provisional application No. 60/928,986, filed on May 14, 2007.

(51) Int. Cl. H04M 3/42

(52) U.S. Cl. 455/417

(57) ABSTRACT

Advanced call services are provided through the use of a mobile phone-resident application configured to automatically call a local number (i.e., one that will not incur long distance charges) of a SIP gateway upon receipt of a call having a recognized ANI. A calling party calls an automated service, provides a called number and is placed on hold. The service calls the called party's number using the recognized ANI. In response, the called party's mobile phone automatically calls back the service at a preprogrammed local number of the SIP gateway and the call back is bridged with the original calling party's call. In this way, calls to remote parties may be placed and connected without incurring long distance charges.

### RELATED APPLICATION

This application is a Continuation-in-Part, under 35 U.S.C. § 111(a), of International Application PCT/US07/80352, having an international filing date of 3 Oct. 2007, which claims priority to and incorporates by reference U.S. Provisional Patent Application Nos. 60/848,905, filed 3 Oct. 2006; 60/855,845, filed 2 Nov. 2006; and 60/928,986, filed 14 May 2007, each of which is assigned to the assignee of the present invention and incorporated by reference herein.

### FIELD OF THE INVENTION

The present invention relates to methods and systems for providing advanced call services to users of conventional landline telephones and voice mobile phones.

### BACKGROUND

Prior to the 1960s, call servicing logic was hardwired in telephone network switches. These switches and the related network infrastructure and rotary dial telephone sets provided what today is known as the “Plain Old Telephone Service” or POTS. Because services were provided via hard-wired circuits, changes to those services needed to be planned years in advance of deployment and, once so implemented, were very difficult to modify.

By the mid-1960s, the hard-wired POTS circuits were being replaced by programmable components. So-called stored program control (SPC) switching systems allowed network operators to more easily provide new services to users. However, because these SPC systems were not yet modularized, the service offerings remained difficult to deploy and inconsistent across different network segments.

By the mid-1970s, carriers had segregated the voice path from the signaling path within a call. The voice path was used to carry the voice information between the callers, while the signaling path was used to carry the call set up information. To handle this call signaling information, the common channel signaling network (CCSN) or SS7 network was developed. This allowed for the introduction of new features such as caller ID, in which the calling party's number (ANI) is transmitted along the signaling path to the called party's station.

By the mid-1980s, increased competition among telephone carriers (brought about by the breakup of AT&T's monopoly in the U.S. telephone industry) saw the introduction of many new call features as these carriers competed for users' business. Within the telephone networks, so-called service control points (SCPs) became the programmable controllers for signaling transfer points (STPs) that made up the SS7 network. The SCPs could be programmed to meet different end user requirements for centralized services such as calling card services and toll-free calls. This was the first introduction of an intelligent network (IN) within the public switched telephone network (PSTN). At first, SCPs were service-specific. Over time, however, these devices became service independent, leading to an advanced intelligent network (AIN). This AIN included a number of different data processing units, each having different functional responsibilities.

The breakup of AT&T also led to a distinction between local exchange carriers (LECs), which handle local telephone calls, and interexchange carriers (IXCs), which handle long distance calls. Local phone calls are defined as calls originating and terminating within a single local access and transport area (LATA). All other calls are long distance calls. The type of call, local or long distance, dramatically affects the rates callers pay for the use of the telephone service.

More recently, with the advent of softswitches, the circuit-switched PSTN has become integrated with the packet-based Internet. As the name implies, softswitches are used to connect calls from one phone line to another, under the control of software running on a computer system, While a single device having both the switching logic and the switching fabric can be used for this purpose; it is more common for these functions to be split between a call agent or media gateway controller (which is generally configured to handle functions such as call routing, signaling and call services) and a media gateway (which is configured to connect digital media streams to create an end-to-end path for the media—voice and data—in the call, under the control of the call agent). The media gateway controller receives signaling information (like dialed digits) from the media gateway and can instruct the media gateway to perform various functions, such as alerting the called party, sending and receiving voice data, etc.

As the softswitch architecture has been rolled out, some long distance carriers have installed media gateways that act as on-ramps and off-ramps for LECs. That is, voice calls that originate within one LATA with one LEC are now transported from the originating LATA to the destination LATA (which may or may not be serviced by the same LEC that services the originating LATA) via a packet switched network operated by the long distance carrier. These packet switched networks commonly use the multiprotocol label switching (MPLS) protocol, which is a hybrid between more traditional network layer protocols and data layer protocols. MPLS can be used to carry many different types of traffic, including Internet protocol (IP) and session initiation protocol (SIP) traffic.

Thus, today a telephone call may involve multiple communication protocols and networks as it originates in a time division multiplexed, LEC-serviced LATA, is terminated at a media gateway where it is converted to SIP for transport across an MPLS or similar based network to another media gateway, where it is converted back to a time division multiplexed signal for transport over the destination “last mile” to the destination point.

### SUMMARY OF THE INVENTION

In one embodiment, the present invention provides for accessing an Internet-based resource by placing a telephone call to a telephone number associated with a port of a media gateway. The Internet-based resource is configured to service the telephone call according to calling party identification information and dialed number identification service (DNIS) information retrieved from the telephone call. The DNIS information may include information associated with a prepaid calling service. The calling party identification information may include caller authentication information.

A further embodiment of the invention provides for completing a call between a calling party and a called party by (1) receiving from the calling party a called number associated with the called party, (2) associating the called number with a local telephone number for use by the called party, (3) providing the local number to the called party, and (4) upon receiving a telephone call from the called party at the local telephone number, connecting the calling party and the called party, wherein the local telephone number is such that a telephone call placed from the called number to the local telephone number does not incur long distance charges. The called number may be received from the calling party via a port of first media gateway that is associated with a telephone number that is local to the calling party's telephone number. The local telephone number for use by the called party may be associated with a port of a second media gateway associated with that local telephone number.

Another embodiment of the invention provides a method for an automated call back from a mobile phone in response to receipt of a call at the mobile phone when information identifying the calling number corresponds to a predetermined telephone number. For example, if the calling number is so identified, an application executing at the mobile phone may, automatically, without user intervention, place a second call to a telephone number associated with a port of a media gateway that is communicatively coupled to one or more computer-based resources configured to connect the second call to an original call by a calling party. That second call is preferably a local call, i.e., one that does not incur long distance charges. The initial call to the mobile phone may be disconnected upon successful connection of the second call to the second telephone number, or even before placing the second call to the media gateway.

Still another embodiment of the invention provides a method in which a call is received from a calling party, and a called number associated with that call is obtained. The called number is stored and a determination is made as to whether the called number is associated with a mobile phone handset configured for automated call back service. If so, an outbound call is placed to the called number, otherwise a short message service (SMS) or other message is sent to the called number. That message may include an indication of a host (e.g., a hyperlink to a web address) from which the called party can download an application to his/her mobile phone to provide the automated call back service. Upon receipt of a call initiated by such an application, that call is bridged with the call from the calling party.

The automated call back from the mobile phone is placed to a telephone number determined by the application to be a local call, i.e., one that will not incur long distance charges. Determining whether or not the called number is associated with a mobile phone handset configured for automated call back service is performed using a first database look-up and determining whether or not to bridge the call back call with the first call from the calling party is performed according to a second database look-up to determine whether or not information identifying an originating number for the call back call corresponds to the called number received from the calling party.

Further embodiments of the invention are described below.

### BRIEF DESCRIPTION OF THE DRAWINGS

The present invention is illustrated by way of example, and not limitation, in the figures of the accompanying drawings in which:

FIG. 1 illustrates an example of a network architecture within which embodiments of the present invention are implemented;

FIG. 2 is a flow diagram illustrating one example of a call flow for advanced call features provided in accordance with embodiments of the present invention;

FIG. 3 illustrates an example of a call flow for Enhanced Global Local (EGL) service according to one embodiment of the present invention;

FIG. 4 illustrates one method for downloading an EGL application to a called party's mobile phone in accordance with embodiments of the present invention, and

FIG. 5 is a simplified diagram shown behavior of an EGL application resident at a called party's mobile phone in accordance with one embodiment of the present invention.

### DETAILED DESCRIPTION

Described herein are methods and systems for providing advanced call services to users of conventional wire-line and mobile phones. Calls originated in the PSTN are terminated at a softswitch (e.g., a media gateway under the control of a media gateway controller), which acts as an access point for a variety of services. Among these services are outbound notification services (e.g., from the calling party to one or more third parties), inbound data collection services (e.g., from Web sites accessible through the softswitch, and call services (e.g., allowing connections to called parties without having to incur long distance tariffs). These and other embodiments of the invention discussed below are provided as examples and should not be read as limiting the scope of the present invention, which is best determined from the claims following this description.

One embodiment of the present invention, which is more fully discussed below, is described as “Enhanced Global Local” (EGL) service. EGL service provides users with means to avoid certain fees (e.g., long distance tariffs) charged by network service providers. EGL service involves the use of a platform-managed automatic call-back feature in a called party's mobile phone. In EGL service, a PSTN voice path is used in both the “first mile” and “last mile” of the overall call path.

Further embodiments of the present invention permit a conventional telephone caller to have a PSTN-originated call directed, transparently, to and from Internet-based resources. This permits delivery of a variety of different services to the caller, including, but not limited to:
a. transmission/reception of email and/or voice mail messages without a computer system;
b. real time call notification when user-specified events occur;
c. network-based short message service (SMS) communications to facilitate conferencing and similar communications;
d. network-based Unstructured Supplementary Service Data (USSD) to invoke a call-back, interactive data service, or similar applications (USSD is a capability of GSM (global system for mobile communications) phones, is generally associated with real-time or instant messaging type phone services, and unlike other message protocols, does not make use of a store-and-forward process; hence, USSD is a convenient “trigger” to invoke advanced calling services, such as the automated call-back service discussed herein); and
e. a user-customizable application interface accessible via telephone communications.

As may be apparent from the above, embodiments of the present invention involve the interconnection of SIP-based networks with TDM (time division multiplexed)-based networks. By interconnecting these two networks, traditional telephone sessions can be established between different applications and devices, including voice-to-voice calls, voice-to-IP calls and voice-to-Internet-based application calls. Conventional telephone devices (i.e., wire-line and/or mobile devices) can be used to create or modify a connection irrespective of whether the actual media content is voice or data.

Previously, SIP adoption within the telecommunications industry has been limited to four categories of applications: (1) hosted, peer-based Voice over IP (VoIP) services; (2) IP private branch exchange systems; (3) client-server desktop enterprise applications; and (4) Internet Multimedia Subsystem (IMS) architectures of wire-line and mobile service providers. Within each category of application, two communication paths have been needed—a data path for SIP messages and an additional voice path for the media—for interconnecting the end-user device (such as a mobile phone or computer) to the transmission network. However, the need for a separate data path places constraints on the deployment of SIP-based services and introduces additional expense. The present invention provides a new category of SIP application—PSTN voice origination—which allows SIP-based services to be accessed over a voice path connection, without the need for a separate data path. This helps to reduce the costs associated with providing SIP-based services.

In one embodiment of the present invention, an Internet-based resource (e.g., an application server) is accessed via a telephone call placed to a telephone number associated with a port of a media gateway. The media gateway retrieves automatic number identification (ANI) information and dialed number identification service (DNIS) information from the telephone call and provides same to the application server (e.g., via a softswitch). Based on this information, the application server may provide one or more predefined services to the call, such as allowing the caller to access a personal contact directory (e.g., names, addresses and/or phone numbers of contacts of the caller), originating multi-party telephone calls, originating calls to remote called numbers, etc. Further examples of services which may be provisioned in this fashion are discussed below. In other cases, rather than an ANI of the calling party, the call may be provisioned in response to the calling party providing authentication information (e.g., such as a personal identification number or an account number). The DNIS information may be a number associated with a prepaid calling service.

Various embodiments of the present invention may be broadly grouped within two application categories. In one category are applications that permit callers to interconnect with Internet-based (or, more generally, data) devices or services, such as services hosted at or available through remote computer systems. In the second category are applications that permit callers to connect with other callers in live, interactive voice conversations, for example for least cost international routing. The first application category can be considered as TDM-to-SIP applications and the second category as TDM-to-SIP-to-TDM applications.

More specifically, among the applications facilitated by the present invention are:
a. International Conferencing. Wire-line and/or mobile phone users on either end of a call dial local telephone numbers (i.e., numbers within their respective LATAs or international equivalents thereof) and are bridged together over an IP network. This avoids long distance tariffs for both parties. The above-mentioned EGL service is one variant of this international conferencing feature. EGL service facilitates an automatic call back from a called party's mobile phone and automated bridging of that call back with the calling party's call. If the automatic call back cannot be initiated at the time of the calling party's call (e.g., if the called party's mobile phone is turned off or is not presently configured for EGL service), the call can be automatically attempted at a later time by initiating the call back from the originally called party's mobile phone.
b. International Messaging. A calling party dials a local number and leaves a message for a called party. The called party receives an SMS or other text service message announcing that a message from the calling party is waiting. The called party dials a local number to retrieve the message. Again, this avoids long distance tariffs for both parties.
c. Multimedia information and entertainment access in real time. Users subscribe to content services delivery to designated devices (e.g., mobile phones, personal digital assistants, personal computers, etc.). In one example, users access foreign radio station broadcasts by dialing local telephone numbers. The radio broadcast is delivered to the user via the telephone connection.
d. Personal Notification Services. Information (e.g., sports scores, road conditions, time announcements, called party line availability, etc.) is delivered according to user-specified account preferences. For example, users may request sporting event scores to be delivered in real time to a selected device. Alternatively, or in addition, a user may request a personal notification message to be delivered daily at a specified time (irrespective of the time zone within which the user is traveling, for example) as a reminder for an event (e.g., to take medication).
e. Auto Conferencing. Mobile phone users can launch conferences from their phone.

Other parties can be connected on-demand or at specified times. Conference participants can join, leave, re-join and involve friends and colleagues at will. In one example, a user may schedule a conference call for 8:00 AM daily, and each participant may be automatically called and bridged into the conference.

f. Ringback Tones. A user may select the tone heard by the calling party when the user is called. The tone may be music or a voice file. In some cases, a personalized greeting may be played for the calling party if the calling party's number (i.e., identified by an ANI) has been associated with a particular tone/file.
g. Flingtones. Users may select a particular ring tone that is played by the called party's handset when a call is placed to that handset. This will trump a different ringtone that had previously been selected by the called party. The flingtone may be music or voice (e.g., a message recorded by the calling party at the time the call is placed). International patent application WO 02/35814 provides an example of such a service.
h. Follow-to-PC. Users may choose how incoming calls should be handled, for example, ringing multiple phones simultaneously or in a particular sequence. The user can then accept the call or forward it to voice mail or email.
i. Wireless Carrier Rebate. Embodiments of the present invention include the use of prepaid calling cards to direct caller traffic to a particular media gateway. Ordinarily, such a system may deprive a wireless carrier of international call tariffs. However, the present invention permits tracking of the actual call destination, allowing such revenues to be captured.
j. Master Directory. Callers may access their individual contact directories from any telephone. Callers can thus retrieve phone numbers and addresses by phone, and then place a phone call or email by speaking the contact's name or number.
k. Multi-Language Messaging. Callers use wire-line/mobile phones to send email messages in the language of the called party. Speech-to-text software deployed at an application server accessible by the softswitch is used to convert the caller's speech into text, which is added to an email directed to an address associated with the called party (e.g., as identified by the called party's telephone number or as identified by the caller through access of a directory).
l. Voice/Speed Dialing. Upon connection to the softswitch (and, optionally, accessing a voice/speed dial application from an interactive voice response (IVR) menu or other menu) callers can place domestic or international calls by speaking the name of the called party or pressing (or speaking) a speed dial code associated therewith. The application would access a previously created directory to obtain the telephone number for the called party.
m. Advertising. The configuration of the network allows for advertising-sponsored telephone calls. That is, in exchange for listening to advertisements, callers (and, optionally, called parties) may be provided with subsidized or free call minutes. Advertisements may be customized according to caller-specified preferences (e.g., as recorded in a caller profile). The advertisements may include video content for playback on devices that are capable of doing so.
n. Auto Return Call. In this example, a calling party's call is acknowledged and then tom down. Thereafter, the softswitch places a call to the original calling party (e.g., as identified by an ANI for the original call) and to the intended called party (e.g., as identified during the original call). The two parties are then connected to one another over a virtual private network (VPN) bridging of the two PSTN calls. Preferably, the two PSTN calls are local calls for the respective call areas,
o. e411 (eInformation). This service replaces or augments conventional directory assistance. Applications accessible to the softswitch provide telephone directory information to the caller in the form of voice and/or text (SMS or email) messages. That information may also be automatically stored in the caller's personal directory for later use.

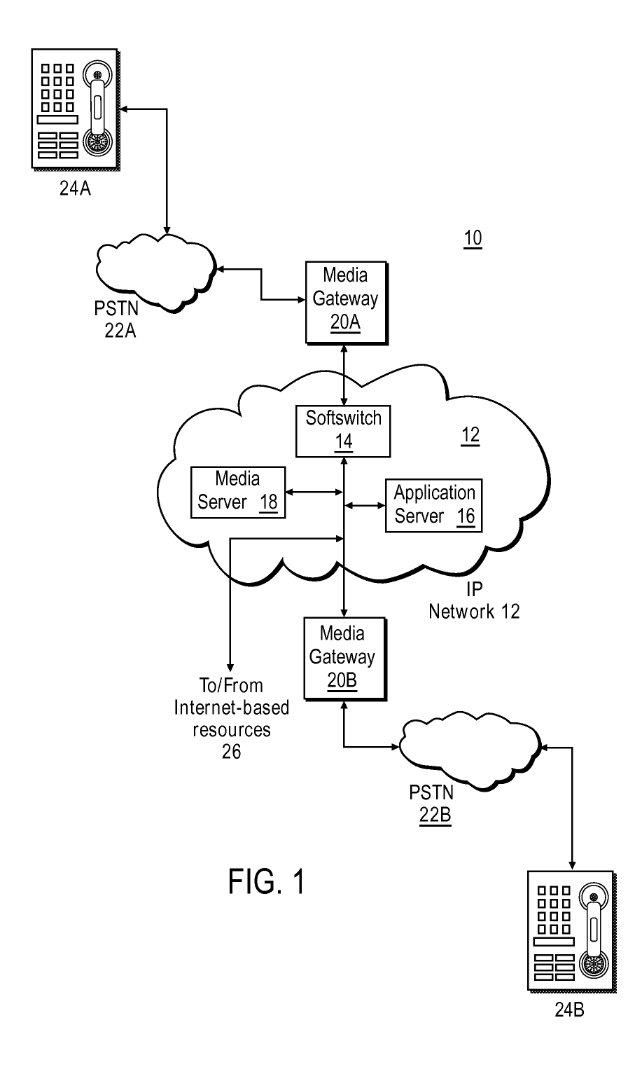

One example of a network architecture for implementing embodiments of the present invention is shown in FIG. 1. System 10 includes an IP network 12 wherein softswitch 14 resides. The IP network may be the Internet or may be a private network. In some cases, IP network 12 will be a private network communicatively coupled to the Internet and accessible therethrough. Softswitch 14 is communicatively coupled to one or more application servers 16 and to one or more media servers 18. Note, in some embodiments, one or more of these functions may be combined in a single server/softswitch, but are shown here as separate functional units for ease of description. Likewise, although not shown in the illustration, a separate server may be used for caller authentication purposes in connection with the use of prepaid calling cards, as discussed further below. Alternatively, caller verification functions may be performed by the softswitch 14 and/or an application server 16.

Softswitch 14 is also communicatively coupled to media gateways 20a and 20b. These media gateways act as call termination points for calls made via PSTNs 22a and 22b, respectively. In some cases, the different PSTNs and media gateways will be located in the same country and/or calling area. Often, however, the respective pairs of PSTNs and media gateways will be located in different countries and/or calling areas. For example, PSTN 22a and media gateway 20a may be located in the United States, while media gateway 20b and PSTN 22b may be located in Guatemala.

Communicatively coupled to the PSTNs 22a and 22b are wire-line or mobile phones 24a and 24b, respectively. Often one of these phones (typically the calling party's phone) will be a wire-line phone, while the other (typically the called party's phone) will be a mobile phone. The precise nature of these phones is not critical to the present invention. What is important is that calls placed to/from the various phones are local calls (for the respective calling area) with respect to the PSTNs with which the phones interoperate. More particularly, these calls are such that they do not incur long distance tariffs.

Also shown in FIG. 1 is a communication path from the softswitch 14 and/or application server(s) 16 to/from other Internet-based resources 26. These may be web sites where a variety of media and information may be obtained in furtherance of some or all of the above-described applications.

In operation, a calling party may place a call from phone 24a. In one embodiment of the invention, the calling party will place the call to a telephone number associated with a prepaid calling card service. That telephone number is associated with a port on media gateway 20a and so the call is transported via PSTN 22a and terminated on media gateway 22a. Preferably this is a local (i.e., non-tariff burdened) call from the standpoint of the PSTN operator.

In some cases, the number dialed by the calling party will be associated with a particular service. In those instances, following user authentication (which may involve requesting and verifying a user's account number or other identifying information to allow for debiting of the user's prepaid account) the associated service is provisioned by softswitch 14 when the call is recognized as having been received on the port of media gateway 20a that is associated with the telephone number of the subject service.

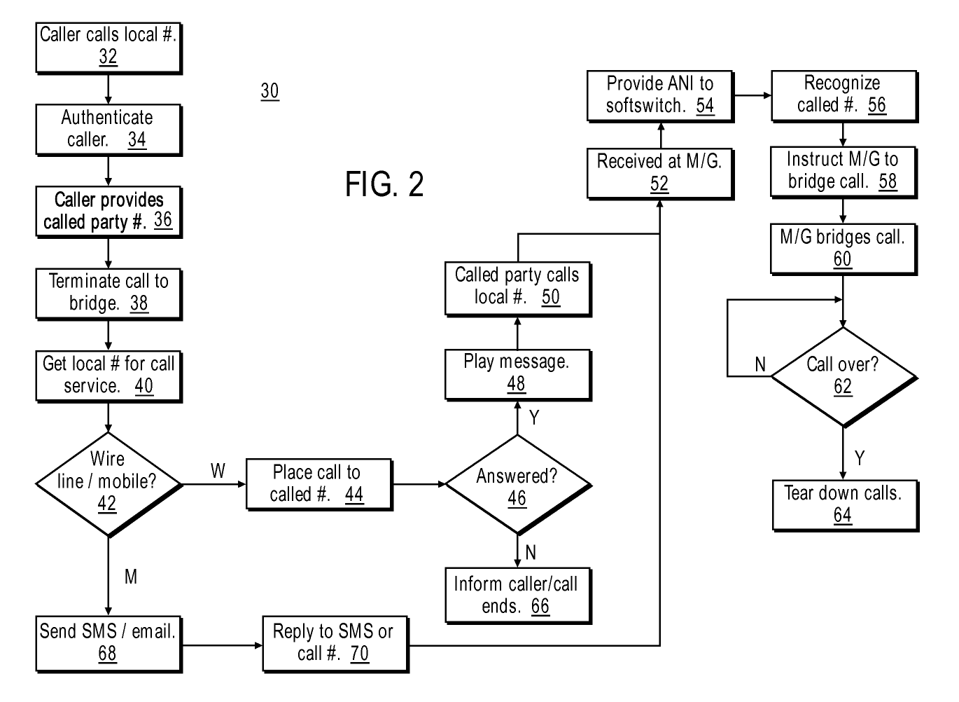

In one particular embodiment of the present invention, the systems 10 may be used to provide very low cost long distance calling services. This is further illustrated in the process 30 shown in the flow diagram of FIG. 2. The process begins with a calling party initiating a call to a local telephone number (e.g., as may be printed on a prepaid calling card) (step 32). As above, the number is associated with a port on a media gateway that is associated with a local PSTN for the calling party. After authenticating the calling party (step 34), for example to ensure that the caller is authorized to use the prepaid card services and/or to verify sufficient funds remain in the account, the caller is prompted to provide the telephone number of the called party (step 36). This may require the calling party to enter the called party's telephone number or the called party may be selected from an existing directory established by the caller. In still other cases, the caller may make use of directory service applications to obtain the called party's telephone number.

Once the called party's telephone number (which may be a wire-line or mobile phone number), has been obtained, the calling party's call may be terminated to a conference bridge (step 38). While on hold on the conference bridge, the calling party may be invited to choose other services (such as the radio broadcast service described above) or may be provided with advertising messages. Alternatively, services such as the radio broadcast service discussed above may be made available at no additional cost.

While the calling party is on hold at the conference bridge, the softswitch (or an application under the control of the softswitch) associates a local telephone number for use by the call service with the called party's number provided by the calling party (step 400). For example, if the called party's number indicates that the called party is in Guatemala, the softswitch (or application) will determine a local Guatemala number for use in connection with the call. This local number may be obtained using a database lookup into a library of available numbers for use by the call service. It is associated with a port on a media gateway in the destination calling area such that a call from that media gateway to the called party's number will be a local call (i.e., one that is not subject to long distance tariffs).

Next, the softswitch (or an application under the control of the softswitch) determines whether the called party's number is a wire-line number or a mobile phone number (step 42). This may be done using an established directory of telephone numbers or it may be information solicited from the calling party before the calling party's call is terminated to the conference bridge. In some cases, the determination can be made based on the telephone number itself.

If the called party's number is a wire-line number (or, optionally, a mobile number, or if it cannot be determined what kind of phone is associated with the called number) then, using the local number obtained from the database lookup, the softswitch directs a call from the EGL platform to the called party's number (step 44). In some instances, the call is placed from an EGL platform that is deemed to be local with respect to the called party and is made using the local number for that calling area. Thus, the ANI of this call will be a local telephone number.

If this call is answered (step 46), a message is played to the called party indicating that the called party-should dial the local number reserved for this purpose in order to reach the calling party on the conference bridge (step 48). Upon completion of the message, the call from the media gateway is torn down. Thereafter, the called party will place a call to the reserved number associated with the local media gateway (step 50). Recall that this is a local number from the standpoint of the local PSTN, hence there are no long distance tariffs associated with the call. When the inbound call from the called party is received at the media gateway (step 52), the called party's number is captured and provided to the softswitch (step 54). Recognizing that this called party's number is associated with the calling party on hold on the conference bridge (step 56), the softswitch instructs the media gateway handling the call from the called party to bridge the call to the existing conference bridge (step 58) so that the callers can be connected. The media gateway then performs this action (step 60). When the call terminates (decision point 62), all of the connections to the conference bridge are torn down (step 64).

If the call to the called party is not successful (e.g., the called party does not answer), the calling party is informed and the calling party's call ends (step 66).

If it was determined that the called number is associated with a mobile phone (step 42), then rather than placing a call to the called party, an SMS or email message may be sent to the called party (step 68) advising that the calling party is awaiting the called party on the conference bridge and providing the reserved local number for the called party to call. In the case of an SMS message, this local number may be used as the ANI of the message originator. Thus, to call the number, the called party need only reply to the SMS message or dial the local number (step 70). At that point, the call is received at the media gateway and the call flow is as described above.

In some cases, the called party may not receive the text message immediately, or may be unable to call at the time when the message is received. In such cases, if the called party does not call the designated local number within a predetermined period of time (say 30 sec to 2 min), the caller is advised that the called party is not available and the original call ends. Should the called party thereafter place a call to the number included in the message, the called party's ANI may be recognized (if saved from the calling party's original call) and the call completed as if the called party were the calling party. That is, the softswitch may direct a media gateway to try and reach the original calling party at the number originally used to call the called party and, if successful, the call can be bridged as a conference. This latter activity is option and is not shown in detail so as not to unnecessarily confuse the drawing.

Notice that the above-described call scenario consists of three legs: a first call from the calling party to the softswitch (via a media gateway local to the calling party), a second call from the softswitch to the called party (via a media gateway local to the called party), and a third call from the called party to the softswitch (via the media gateway local to the called party). In each instance, the call is a local call, that is, none of the call legs are subject to long distance tariffs (or to other surcharges). The long distance portion of the call is handled through the IP network 12. The legs of the call may be described as phone-to-net, net-to-phone, and phone-to-net. Although IP traffic is involved, all of these calls use only the voice path in the respective PSTNs between the calling stations and not an additional data path.

An alternative embodiment of the invention is the above-mentioned EGL service. Conventional international calls, for example from the United States to a foreign country, typically incur significant charges (e.g., often in the form of per-minute charges which include carrier fees and government tariffs). While VoIP services such as those offered by Skype™, Google Voice™ and others are able to reduce those charges, such services usually require the use of a personal computer or similar data device to both originate and terminate the call over an Internet (i.e., Internet protocol) connection, and do not generally allow calls to mobile phones over the PSTN voice path. When a VoIP service is used to place a call to a non-VoIP station, that call may (usually will, in the case of international calls) incur tariff costs on the terminating end. The present EGL service overcomes these limitations. For example, the EGL service is especially useful in situations where a called party does not have access to an Internet connection or a VoIP-capable device. So long as the called party has a mobile phone running the EGL application, that phone can make use of the EGL call-back feature to reduce or eliminate the tariff costs of international calls for VoIP-type services.

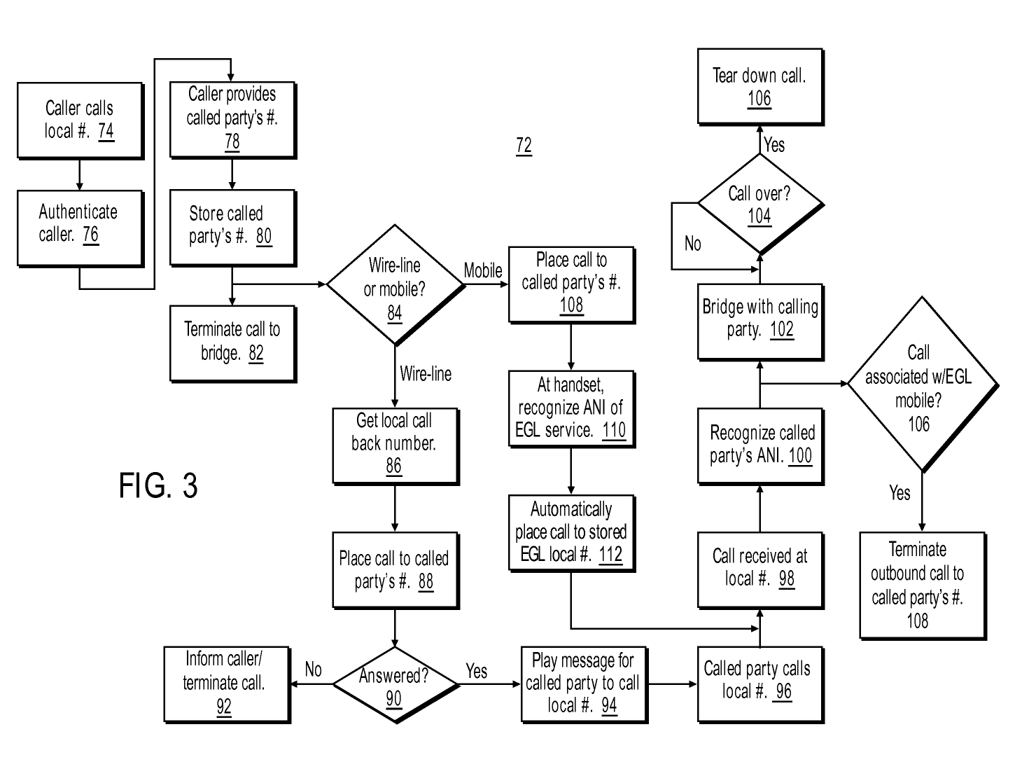

FIG. 3 illustrates an example of a call flow 72 for EGL service according to one embodiment of the present invention. The call flow begins in much the same fashion as that discussed above, with a calling party placing a call to a local number associated with a media gateway or other SIP gateway 74. The SIP gateway is IP addressed to another platform (e.g., an application server) for interactive voice response (IVR) interaction with the caller and termination of the call to a conference bridge. Accordingly, the caller is authenticated (e.g., on the basis of a personal identification number or other means) 76, queried for the called party's telephone number 78, which is stored for later use by the platform 80, and the call is terminated to a conference bridge 82.

As the call is being terminated to the conference bridge (or thereafter), the platform (e.g., an application server) determines whether the calling party is calling a wire-line number or a mobile telephone number 84. For many countries outside the United States, the prefix of the called party's number may be used to determine whether the associated telephone is a wire-line phone or a mobile phone. In other instances, databases may need to be queried to make this determination. In some cases, if it cannot be determined whether the call is to a wire-line phone or a mobile phone, the platform may assume that the call is to one or the other and proceed accordingly.

Assuming that the call is being placed to a wire-line phone, the platform consults an appropriate database and determines a local call back number for the called party to use 86. Thereafter, a call is placed from the platform to the called party's number 88. This call may make use of a platform that is local to the called party's number.

If the outbound call from the platform is not answered, 90, then the calling party is so informed and the call is terminated 92. Otherwise, if the call is answered, the called party is advised of the calling party's call and is provided with the local number to be used for call back purposes 94. This is the local number of a SIP gateway that can be called without the called party incurring long distance calling charges.

The called party calls the local number provided 96 and that call is received at the local SIP gateway and IP routed to the platform 98. At the platform, the called party's ANI is recognized 100 (e.g., it may be compared to the stored numbers from step 80 and matched accordingly) and the call back from the called party is then bridged with the call from the original calling party 102. The call takes place between the parties 104, and the calls are torn down when over 104.

To this point, the EGL service mimics (for the most part) the call service described above. However, if the called party's number is recognized as or determined to be a mobile phone number 84, the process is somewhat different from the example discussed above with reference to FIG. 2. Instead of sending an SMS or other message to the called party's mobile phone, with EGL service the platform places an outbound call to the called party's mobile phone over the regular voice path 108. This call is placed using a specific ANI, which will be referred to as an EGL ANI. The EGL ANI is such that an application resident on the called party's mobile phone will recognize the EGL ANI 110 and, in response, automatically place an outbound call to a predetermined number 112. This outbound number is a local number associated with a local SIP gateway so that the call from the called party's handset will not incur long distance charges. The number is preprogrammed for use by the handset-resident application upon recognition of the EGL ANI.

Thereafter, as discussed above, the call is received at the local SIP gateway number 98, recognized as coming from the called party 100, and bridged with the calling party 102. The call takes place between the parties 104, and the calls are torn down when that call is over 104. As shown in FIG. 3, when the ANI of the called party's call back is recognized, the platform checks to see if that ANI is associated with an outbound call to a mobile phone 106. If so, the outbound call is terminated 108. This way, only the call back call is active at the called party's mobile phone. In some instances, the outbound call to the called party's mobile phone may be terminated earlier so that the called party does not answer the call. Or, the application resident at the called party's mobile phone may be configured to prevent the ringer of the mobile phone from activating when the EGL ANI is recognized so as to preclude the called party from answering the associated call from the EGL platform.

The call to the called party's mobile phone from the EGL platform may be made via the PSTN. As indicated above, the EGL platform inserts an EGL-specific ANI (EGL ANI) in this call. A previously stored application resident at the called party's mobile phone recognizes the EGL ANI and, in response, automatically initiates the call back to a previously stored number associated with a local SIP gateway. Different SIP gateway numbers may be obtained for use when the called party's mobile phone is roaming outside of its customary area. For example, the application may include features that allow the called party to specify where the phone will be used and to download and store local SIP gateway numbers for those areas. Upon receiving a call with the EGL ANI, the application may determine (e.g., from network data or other location services) where the mobile phone is being used and make use of an appropriate SIP gateway call back number from a previously stored set thereof. Alternatively, the handset may request (e.g., from the EGL platform) a local SIP gateway number upon receipt of a call with the EGL ANI. Such a number could be provided to the application as an SMS or other message.

At the EGL platform, when the call back from the called party's mobile phone is recognized, that call is bridged with the original call from the calling party. Bridging may be done via a database look-up at the platform and matching of the ANI of the called party to the DNIS provided with the original calling party's call (which was received as part of the initial IVR interaction between the calling party and the EGL platform). Upon successfully bridging the two calls, or even prior thereto, the call from the platform to the called party's mobile phone may be dropped. This way the call from the calling party is connected to the called party via two locally dialed calls. The legacy PSTN international network is bypassed and no long distance charges are incurred by either party.

In the some instances, the called party's mobile phone may not include a copy of the local application for use with the above-described EGL service. This may be recognized at the time the calling party places the call. For example, during that call, the calling party is queried for the called party's mobile phone number. Upon receiving that information, the platform may consult a database to determine whether or not the associated mobile phone handset has previously downloaded a copy of the EGL application or whether such an application was provided with the associated mobile phone at the time of its purchase. If not, the calling party may be so advised and instructed to call back after the called party has downloaded an appropriate application, or advised that the time on hold may be longer than would otherwise be the case because the called party will have to download an appropriate application as part of the call initiation process, or that the called party should expect a call back once the called party has downloaded the appropriate application and is connected to the platform (i.e., indicating that the platform will call back the original calling party to bridge a call with the originally called party).

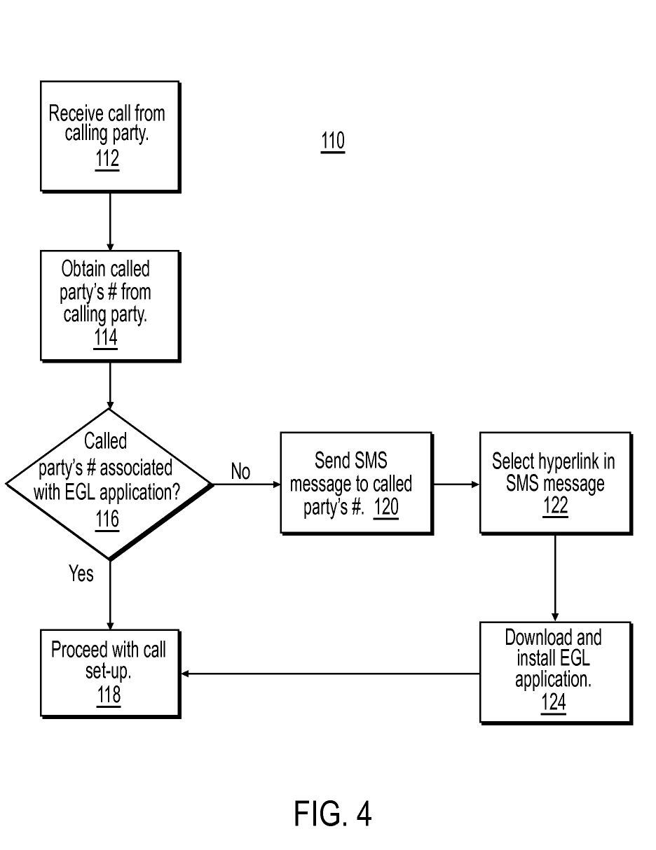

One method 110 for downloading an EGL application to a called party's mobile phone is illustrated in FIG. 4. At 112, a call from a calling party is received at the EGL platform (e.g., via a SIP gateway as discussed above). As part of an IVR or other session with the caller, the platform obtains the called party's mobile phone number 114. The platform then consults a database to determine whether or not this number is associated with a mobile phone handset that is recognized as having previously been provisioned with an EGL application (e.g., either at the time of original sale or subsequently thereafter via download) 116. If so, the platform continues with the call set 118, as discussed above with reference to FIG. 3.

If the called party's number is not recognized as being associated with a mobile phone handset that has been provisioned with an EGL application, then the EGL platform will send an SMS or other message to the called party's number 120. In one embodiment, the SMS or other message includes an indication of a host (e.g., a hyperlink to a web address) from which the called party may download the EGL application suitable for the called party's handset (different handsets/operating systems will require different versions of the EGL application as each operates somewhat differently, however, such implementation details are not critical to the broader scope of the present invention). By selecting the hyperlink, 122, the called party may download the appropriate EGL application and install same to the called party's handset 124.

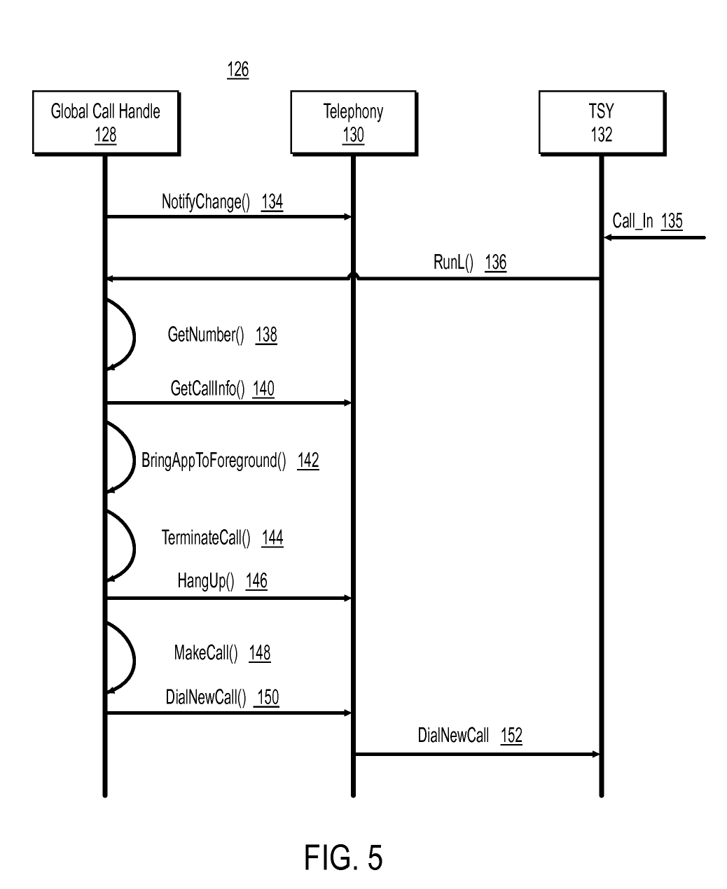

Once downloaded, the EGL application may be stored in memory or another computer-readable storage medium of the mobile phone handset. Such an application may comprise computer-readable instructions for execution by a processor of the mobile phone handset and in executing such instructions the processor may perform the operations discussed below in connection with FIG. 5. The downloading and installation of applications identified in SMS messages and the like is known in the art, however, the present invention is distinguished from such prior applications in that the EGL application operates so as to override features of the mobile phone's operating system. Specifically, and as noted above, the EGL application, once installed, monitors incoming calls to determine the ANI of such calls and, upon recognizing an inbound call having an EGL ANI (of which there may be more than one), immediately places an outbound call to a predetermined number associated with a local SIP gateway (optionally, without informing the called party of the inbound call until such time as the call back call is connected).

As part of the process of downloading the EGL application to the called party's mobile phone, the EGL platform will have used the DNIS from the called party's mobile phone to perform a database look-up to determine the local SIP gateway number to be used by the called party for call back purposes. That number can be preprogrammed into the EGL application provided to the called party's phone so that the local number of the SIP gateway is prestored for use during call back operations. Alternatively, or in addition, the EGL application may be configured to allow the called party to select one or more local SIP gateway numbers for use when roaming or for other purposes. Or, when the EGL application recognizes that the called party's phone is outside its customary call area, the application may automatically obtain an appropriate SIP gateway number from the EGL platform for use in the current area. This may be done, for example by placing a voice or SMS call to the platform, with or without the called party's knowledge.

Once the called party's mobile phone handset has installed a copy of the EGL application, the call may proceed in the manner described above 118. Alternatively, if the calling party was not on hold during this time, the called party's handset may be instructed to place a call to the local SIP gateway number and, using the DNIS from that call to identify the original calling party, the platform may initiate a new outbound call to the original calling party (e.g., via a PSTN local to the calling party) and bridge the calls.

FIG. 5 is a simplified diagram showing behavior 126 of an EGL application resident at a called party's mobile phone in accordance with one embodiment of the present invention. In this example, upon recognizing the call from the EGL ANI, the EGL application terminates that call before placing its own outbound call to the local SIP gateway number. Shown in the illustration are three exemplary applications, Global Call Handle 128, which is the highest layer for the present EGL application, Telephony 130, which is the mobile phone's resident telephony application, and TSY 132, which is an application used to place and receive calls over the air. Note, these examples are used merely for purposes of explanation and the actual applications and application programming interfaces (APIs), calls and other routines used by an actual mobile phone and its operating system may be different. This example should not be read to limit the scope of the present invention, which is broadly applicable to any mobile phone handset/operating system combination. The figure shows examples of program calls to the APIs of the various applications.

Once installed, at 134 the Global Call Handle application advises the Telephony application that it is resident and instructs the Telephony application to pass on notifications of any changes in the status of the mobile phone's voice channel. At 135, the TSY application receives an inbound call. The Global Call Handle application is advised of the new call 136, and the application obtains the ANI of the new call 138 by instructing the Telephony application to pass that information 140.

Assuming the ANI is recognized as the EGL ANI, the Global Call Handle application moves to the foreground in the processing stack 142, decides to terminate the inbound call 144, and sends an appropriate instruction to the Telephony application to hang up the call 146 (alternatively, this call may be held until such time as the call back to the local SIP gateway has been connected, or even until the call back has been bridged with the calling party's call). The Global Call Handle application then initiates a new call 148. The programmed number for the local SIP gateway is passed to the Telephony application along with instructions to place the call 150. This is passed on to the TSY application 152 and the call is placed. This corresponds to the call back from the called party's mobile phone.

In the event the ANI of the incoming call is not the EGL ANI, the Global Call Handle application would remain in the background and the call would be processed by the Telephony application according to its customary procedures for same. Likewise, if for any reason the called party decided to reject the inbound call from the EGL platform, the Global Call Handle application would instruct the Telephony application to hang up the call but would not place the outbound call to the SIP gateway. If such a call had already been placed, the user could manually hang up the call in the usual fashion and the Global Call Handle application would revert to the background.

Still another embodiment of the present invention makes use of the EGL call-back service, but in this instance the call-back is invoked by a direct call from the calling party. For example, the calling party may place a call into the EGL platform and instruct the platform (e.g., via an appropriate IVR or other application) to place the call on hold. Next, the calling party may directly dial the called party over the PSTN using a second line available to the calling party. For example, the calling party may use a wire-line telephone to call the EGL platform and use a second line, if available, or a separate phone to directly call the called party's mobile phone. The direct call to the called party is placed such that an ANI associated with the telephone number used by the calling party is recognized at the called party's mobile phone as one that should trigger the automatic call-back process. That is, upon recognizing the ANI of the calling party's call, the EGL application running on the called party's mobile phone automatically calls the EGL platform in the fashion described above. Alternatively, if no EGL application is running on the mobile phone or the calling party's ANI is not recognized as one for which an automated call-back to an EGL platform should be placed, the called party may recognize the calling party's number displayed at the called party's mobile phone and instead of answering the call may place a call directly to the EGL platform. Such a call would be to a local number from the standpoint of the called party's mobile phone. Once connected to the EGL platform, whether through means of an automated call-back or a manual call into the platform, the called party is connected to the calling party that is waiting on hold. This may be done, in the case of the automated call-back, by recognizing the ANI from the called party's mobile phone or, in the case of a manual call, by the called party identifying the calling party's number once connected to the platform. One benefit of this embodiment of the invention is that calling party does not require a calling card service or a VoIP service to place the call to the called party.

Thus, methods and systems to provide advanced call services to users of conventional wire-line and mobile phones have been described. It should be recognized that the examples discussed above, however, are not intended to limit the scope of the present invention. Although examples of the types of services that can be provisioned. through the network architecture described herein were given, these should not be read as limiting the invention to just these exemplary services. Instead, the invention should only be measured in terms of the claims following this description.

What is claimed is:

1. A method, comprising, at a mobile phone and in response to receipt of a second call at the mobile phone via a voice channel, automatically determining whether information identifying the calling number corresponds to a recognized telephone number associated with a service, and, if so, automatically, without user intervention, placing a third call to a telephone number associated with a port of a media gateway that is communicatively coupled to one or more computer-based resources configured to connect the third call to a first call, the first call having been placed to the service prior to the second call being placed to the mobile phone.

2. The method of claim 1, wherein the third call is a call that does not incur long distance charges.

3. The method of claim 1, wherein the second call is disconnected upon successful connection of the third call.

4. The method of claim 1, wherein the second call is disconnected before placing the third call.

5. A method, comprising:
receiving from a calling party, a called number associated with a called party;
storing the called number and determining whether the called number is associated with a mobile phone handset configured for automated call back service; and, if so,
placing an outbound call to the called number, otherwise
sending to the called number a message that includes an indication of a host from which the called party can download an application to provide the automated call back service.

6. The method of claim 5, wherein the message comprises one of a short message service (SMS) message or an Unstructured Supplementary Service Data (USSD) message.

7. The method of claim 5, wherein the indication of the host comprises a hyperlink.

8. The method of claim 5, further comprising upon receipt of a call initiated by the application to provide the automated call back service, bridging the call initiated by the application with the call from the calling party.

9. The method of claim 8, wherein the call initiated by the application is placed to a telephone number determined by the application to be one that will not incur long distance charges.

10. The method of claim 5, wherein determining whether the called number is associated with a mobile phone handset configured for automated call back service comprises performing a first database look-up.

11. The method of claim 10, further comprising receiving a call initiated by the application and determining whether or not to bridge the call initiated by the application with a first call from the calling party according to a second database look-up, the second database look-up to determine whether or not information identifying an originating number for the call initiated by the application corresponds to the called number associated with a called party received from the calling party.

12. A computer-readable storage medium having stored therein computer-readable instructions, which instructions, when executed by a processor, cause the processor to perform a process, said process comprising determining whether information identifying a calling number of a call received via a voice channel corresponds to a predetermined telephone number, and, if so, automatically initiating an outbound call to a telephone number associated with a port of a media gateway.

13. The computer-readable storage medium of claim 12, wherein the call to the telephone number associated with the port of the media gateway is a call that does not incur long distance charges.

14. The computer-readable storage medium of claim 12, wherein the process further comprises disconnecting the call received via the voice channel upon successful connection of the call to the telephone number associated with the port of the media gateway.

15. The computer-readable storage medium of claim 12, wherein the process further comprises disconnecting the call received via the voice channel before placing the call to the telephone number associated with the port of the media gateway .

16. A method, comprising:
receiving, at a platform, a first call from a calling party, and receiving, during the first call, a telephone number associated with a called party;
placing, from the platform, a second call to the telephone number associated with the called party, the second call being made via a public switched telephone network (PSTN) and using a platform-specific automatic number identifier (ANI) different from an ANI associated with the calling party;
receiving the second call at a mobile phone handset associated with the called party's telephone number and, upon recognizing the platform-specific ANI, automatically placing a third call from the mobile phone handset to a computer-based resource associated with the platform; and
bridging the third call with the first call.

17. The method of claim 16, wherein the third call is placed without informing the called party of the second call.

18. The method of claim 16, wherein prior to placing the second call to the telephone number associated with the called party, determining whether an automated call-back application has been downloaded to the mobile phone handset.

19. The method of claim 18, wherein if the automated callback application has not been downloaded to the mobile phone handset, then arranging for a download of the automated call-back application to the mobile phone handset.

20. The method of claim 20, wherein during the download of the automated call-back application to the mobile phone handset, storing one or more telephone numbers associated with one or more gateways communicatively coupled to the platform, said one or more telephone numbers being numbers for use when the mobile phone handset is located in calling areas for which calls to respective ones of one or more telephone numbers do not incur long distance charges.

21. The method of claim 16, wherein prior to placing the third call, automatically obtaining a telephone number for the computer-based resource associated with the platform, said telephone number being one for which the third call will not incur long distance charges.

22. A method, comprising:
receiving, at a platform, a first call from a calling party, and placing the first call on hold;
placing, from the called party, a second call to a telephone number associated with the called party, the second call being made via a public switched telephone network (PSTN);
receiving the second call at a mobile phone handset associated with the called party's telephone number and, upon recognizing the second call as originating with the called party, placing a third call from the mobile phone handset to a computer-based resource associated with the platform; and
bridging the third call with the first call.
